(19) United States
(12) Patent Application Publication
(10) Pub. No.: US 2013/0303026 A1
(43) Pub. Date: Nov. 14, 2013

(54) CONNECTOR

(71) Applicants: Tse Hsine Liao, New Taipei City (TW); Hui Ling Chung, New Taipei City (TW); Chung Wei Chiang, New Taipei City (TW); Ju Yi Hung, New Taipei City (TW)

(72) Inventors: Tse Hsine Liao, New Taipei City (TW); Hui Ling Chung, New Taipei City (TW); Chung Wei Chiang, New Taipei City (TW); Ju Yi Hung, New Taipei City (TW)

(73) Assignee: GIGA-BYTE TECHNOLOGY CO., LTD.

(21) Appl. No.: 13/603,175

(22) Filed: Sep. 4, 2012

(30) Foreign Application Priority Data
May 11, 2012 (TW) 101116773

(51) Int. Cl. H01R 24/58

(52) U.S. Cl. 439/626

(57) ABSTRACT

A memory connector with an increased pin interval is disclosed including a main body and a plurality of pins. The body includes a bottom, and the pins are disposed on the bottom along a longitudinal direction in an interlaced way. A recess is formed on the bottom of the main body corresponding to each of the pins at one end of the pin. The arrangement of the pins therein solves the problem of insufficient space for wiring lines of the main board, which is occurred frequently when the pins are fabricated by an SMD process, without increasing any manufacturing cost in particular.

This application claims the benefit of the filing date of Taiwan Patent Application No. 101116773, filed on May 11, 2012 with the Taiwan Intellectual Property Office, the disclosure of which is incorporated herein in its entirety by reference.

### BACKGROUND OF THE INVENTION

1. Field of the Invention

The present invention is related to a connector, and more particularly related to a memory connector with a larger interval between pins for facilitating the design of the circuit layout.

2. Description of the Prior Art

As the progress of the semiconductor process, the manufacturing cost of the electronic device is reduced. However, the circuit layout usually has to be varied with the progress of the process. For example, the Dynamic Random Access Memory (DRAM) connector of the conventional computer uses the technique of Dual Inline Package (DIP) to fabricate the pins of the connector. Recently, however, the Surface Mount Device (SMD) package process has been widely used for replacing the conventional DIP process.

If the pins of the DRAM connectors are all made by the SMD process, redesigning the circuit layout on the surface of the main board is inevitable, as the interval of the pins of the connector made by the SMD process is smaller than that made by the DIP process. Under this circumstance, the available space for the wiring lines is reduced and the number thereof will be dropped from a maximum of 3 to only 1, thus increasing the difficulty in the circuit design on the main board.

FIG. 1 is a schematic view illustrating the pins of the connector 100 made by the conventional DIP process, while FIG. 2 is a schematic view illustrating the connector 200 made by the SMD process. As shown in FIG. 1, in the DRAM connector 100, the pins 102 made by the DIP process is arranged in four rows with irregular symmetry on the bottom of the connector 100. As shown in FIG. 2, in the memory connector 200, the pins 202 made by the SMD process is arranged in two rows with regular symmetry. The pins 202 in the same row has a smaller interval than the pins 102 in the same row in FIG. 1. Therefore, there is a need for a memory connector having an increased interval between the pins which are made by the popular SMD process.

### SUMMARY OF THE INVENTION

In view of the forgoing problems, the object of the present invention is to provide a memory connector with an increased pin interval without significantly changing the wiring pattern of the main board.

In another embodiment of the present invention, the pins further includes a first row of pins on a first side of the bottom of the main body; a second row of pins adjacent to and respectively disposed interlacedly with the first row of pins; a third row of pins adjacent to the second row of pins; and a fourth row of pins on a second side of the bottom of the main body and respectively disposed interlacedly with the third row of pins.

### BRIEF DESCRIPTION OF THE DRAWINGS

FIG. 1 is a schematic view illustrating the pins of the memory connector made by a conventional DIP process;

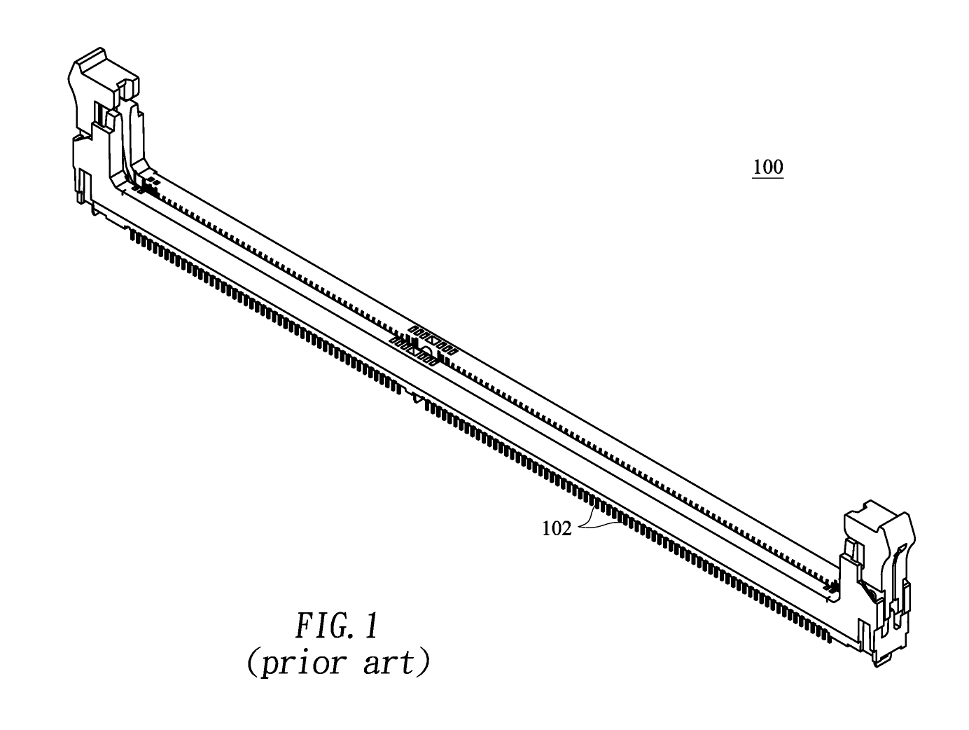

FIG. 2 is a schematic view illustrating the memory connector made by an SMD process;

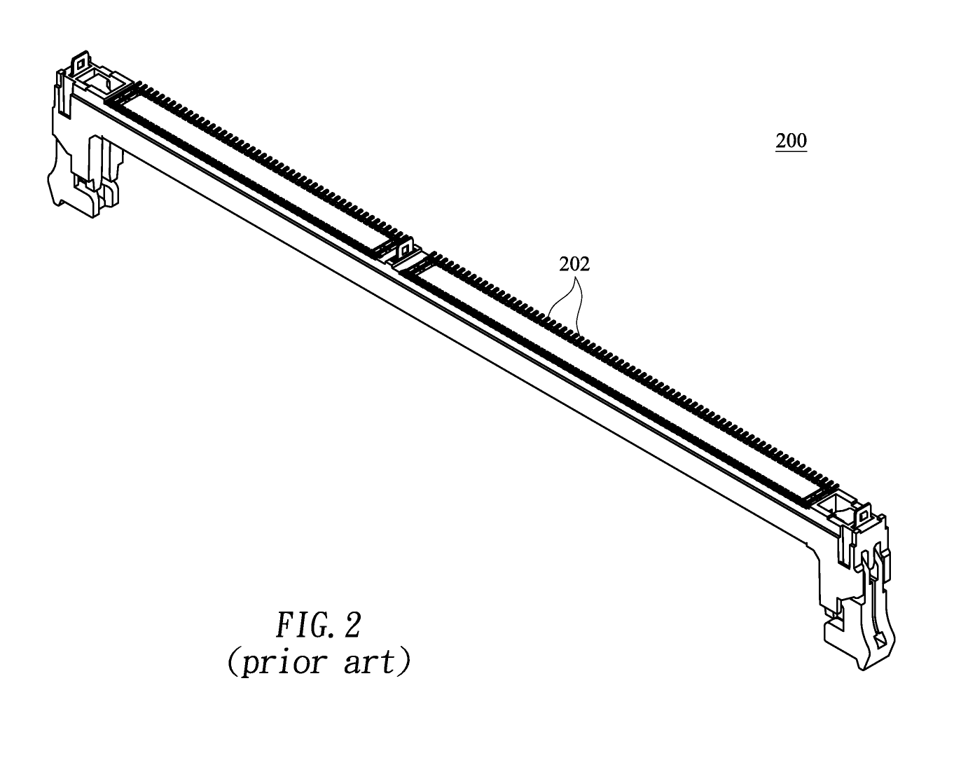

FIG. 3 is a schematic view illustrating a connector in a preferred embodiment of the present invention;

FIG. 4 is a schematically partial enlarged view illustrating the pins of the connector in the present invention; and

FIG. 5 is a side view illustrating the connector in the preferred embodiment of the present invention.

### DETAILED DESCRIPTION OF THE INVENTION

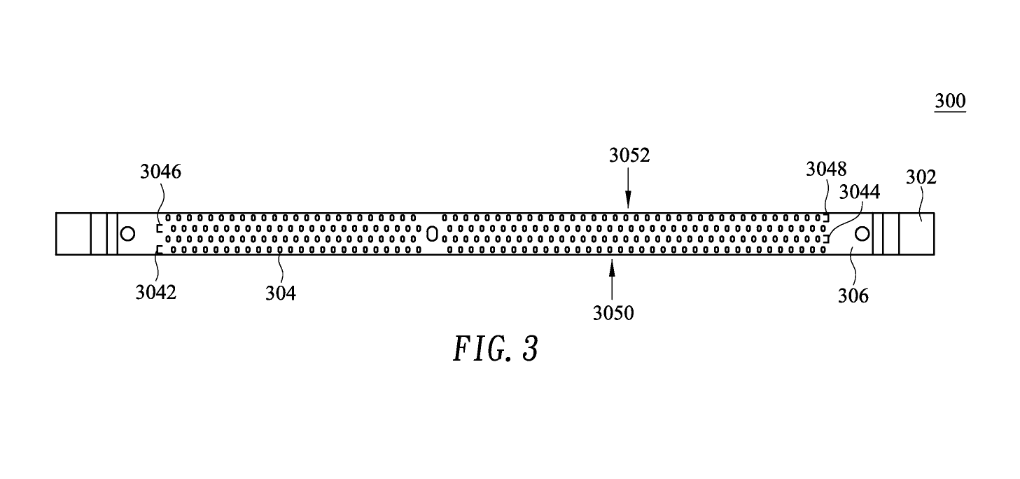

FIG. 3 is a schematic view illustrating a connector in a preferred embodiment of the present invention. As shown in FIG. 3, the connector 300 is a Dynamic Random Access Memory (DRAM) connector, but it is illustrative rather than limitative. The connector 300 includes a main body 302 and a plurality of pins 304, and the pins 304 are made by Surface Mount Device (SMD) process. The pins 304 which are generally divided into a first row of pins 3042, a second row of pins 3044, a third row of pins 3046 and a fourth row of pins 3048, are respectively disposed on the bottom 306 of the main body 302 in an interlaced way. The first row of pins 3042 and the third row of pins 3046 are symmetrically disposed with a central line of the bottom 306 of the main body 302 along a longitudinal direction as an axis of symmetry. Also, similarly, the second row of pins 3044 and the fourth row of pins 3048 are symmetrically disposed with the central line along the longitudinal direction as the axis of symmetry. The first row of pins 3042 are located close to the first side 3050 of the bottom 306 of the connector 300, and the second row of pins 3044 are adjacent thereto and respectively interlaced therewith in terms of row, as can be seen from FIG. 3. In addition, the fourth row of pins 3048 are disposed close to the second side 3052 of the bottom 306 of the connector 300, and the third row of pins 3046 are adjacent thereto and respectively interlaced therewith. It is noted that in such arrangement the second pins 3044 and the third pins 3046 are also adjacent to each other. In the present embodiment, the first side and the second side refer to the opposite sides of the bottom surface of the connector.

In the above arrangement of four rows, an interval between the pins is increased when compared with the conventional connector made by the SMD process. Besides, with the interlaced arrangement, it is possible for one to three signal wires to be located between the pins 304 of adjacent rows. Therefore, the circuit layout on the main board has no need to be changed correspondingly.

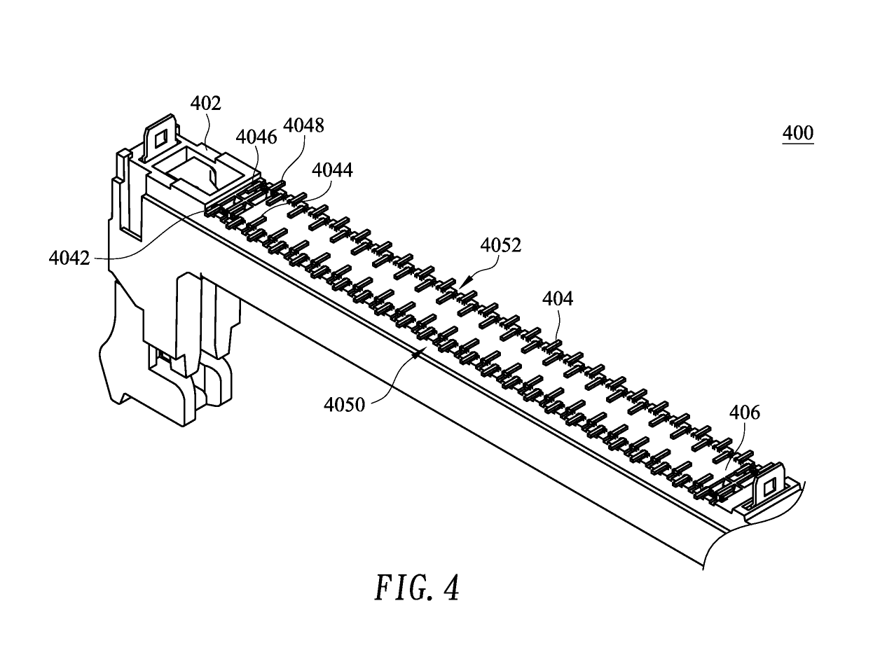

FIG. 4 is a schematically partial enlarged view of the pins of the connector in the present invention. As shown in FIG. 4, by comparing to the pins made by the conventional SMD process, in the connector 400 of the present invention, the first and the third rows of pins 4042 and 4046 are bent and directed toward the first side 4050 of the bottom 406, while the second and the fourth rows of pins 4044 and 4048 are bent and directed toward the second side 4052 of the bottom 406. However, it should be noted that in practice the pins 404 may be bent and directed in different orientations in other embodiments. For example, the first row of pins 4042 may be bent and directed toward the second side 4052 and the second row of pins 4043 may be bent and directed toward the first side 4050 of the bottom 406. Because the pins 404 in adjacent rows are arranged to be bent and directed toward different orientations, the interval between the pins 404 in the same row is increased for more wiring lines, thereby improving the extendibility in the design of the circuit layout.

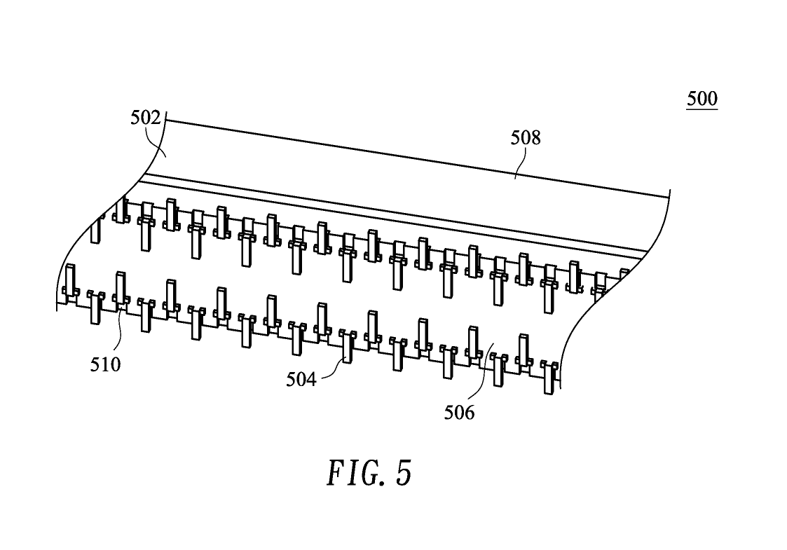

FIG. 5 is a side view illustrating the connector in a preferred embodiment of the present invention. As shown in FIG. 5, the connector 500 includes a main body 502 and a plurality of pins 504. It is preferred that the bottom 506 has smaller width than the top 508 in order to facilitate the alignment of the pins 504 and the wiring lines of the main board. In this way, it is helpful for the user to check if the pins 504 are aligned with the wiring lines of the main board when assembling. However, on the other hand, in the connector 500 of the present invention, since part (one-half) of the pins 504 are bent toward the middle part of the bottom 506, it is difficult to directly examine if they are all aligned with the wiring lines of the main board as expected. Therefore, a recess 510 is formed on the bottom 506 corresponding to each of the pins 504 at one end thereof. With the help of the recesses 510, the wiring lines can be seen easily when the user looks downward during the process of assembling. According to the design described above, when the connector 500 is welded on the main board, whether each of the pins 504 is electrically connected to the corresponding wiring line can be observed effortlessly with eyes. Preferably, the connector 500 in the present invention is Double Inline Memory Module (DIMM) based on Double Data Rate 3 (DDR 3) DRAM. It is also obvious from FIG. 5 that the directions toward which the pins 504 direct are not consistent. The variation of the directing direction leads to an interlaced arrangement of the pins 504. The interval between the pins 504 in the same row is larger (about 25˜30 mils, usually 28 mils) and may sufficiently contain 1˜3 wiring lines.

The above arrangement of the pins not only has an increased interval between the pins in the same row but also reduces the difficulty in the circuit layout. Besides, since only the arrangement of pins is involved without any additional step in the process of making a conventional connector, no extra manufacturing cost is required.

The present invention has been disclosed as mentioned above and it is understood the embodiments are not intended to limit the scope of the present invention. Moreover, as the contents disclosed herein should be readily understood and can be implemented by a person skilled in the art, all equivalent changes or modifications which do not depart from the spirit of the present invention should be encompassed by the appended claims.

What is claimed is:

1. A connector, comprising:
a main body including a bottom and defining a longitudinal direction; and
a plurality of pins disposed on the bottom along the longitudinal direction in an interlaced way;
wherein, the pins are made by a Surface Mount Technology (SMT) process.

2. The connector of claim 1, wherein the plurality of pins includes:
a first row of pins on a first side of the bottom of the main body;
a second row of pins adjacent to and respectively disposed interlacedly with the first row of pins;
a third row of pins adjacent to the plurality of the second pins; and
a fourth row of pins on a second side of the bottom of the main body and respectively disposed interlacedly with the third row of pins.

3. The connector of claim 2, wherein the first row of pins and the third row of pins are bent and directed toward the first side, and the second row of pins and the fourth row of pins are bent and directed toward the second side.

4. The connector of claim 2, wherein the first and the third rows of pins are symmetrically disposed with a central line of the bottom of the main body along the longitudinal direction as an axis of symmetry, and the second and the fourth rows of pins are symmetrically disposed with the central line of the bottom of the main body along the longitudinal direction as the axis of symmetry.

5. The connector of claim 1, wherein a recess is formed on the bottom of the main body corresponding to each of the pins at one end of the pin.

6. The connector of claim 1, wherein an interval between the pins is about 25˜30 mils.

7. A connector, comprising:
a main body including a bottom and defining a longitudinal direction;
a first row of pins on a first side of the bottom of the main body;
a second row of pins adjacent to and respectively disposed interlacedly with the first row of pins;
a third row of pins adjacent to the second row of pins; and
a fourth row of pins on a second side of the bottom of the main body and respectively disposed interlacedly with the third row of pins;
wherein the first and the third rows of pins are bent and directed toward the first side of the bottom of the main body, and the second and the fourth rows of pins are bent and directed toward the second side of the bottom of the main body.

8. The connector of claim 7, wherein a recess is formed on the bottom of the main body corresponding to each of the pins at one end of the pin.

9. The connector of claim 7, wherein an interval between the pins is about 25˜30 mils.

10. The connector of claim 7, wherein the first and the third rows of pins are symmetrically disposed with a central line of the bottom of the main body along the longitudinal direction as an axis of symmetry, and the second and the fourth rows of pins are symmetrically disposed with the central line of the bottom of the main body along the longitudinal direction as the axis of symmetry.
